(19) United States
(12) Patent Application Publication
(10) Pub. No.: US 2024/0057113 A1
(43) Pub. Date: Feb. 15, 2024

(54) TRANSMISSION TIMING BASED ON DOWNLINK CONTROL INFORMATION

(71) Applicant: LENOVO (BEIJING) LIMITED, Beijing (CN)

(72) Inventors: Chenxi Zhu, Fairfax, VA (US); Bingchao Liu, Beijing (CN); Wei Ling, Beijing (CN); Yi Zhang, Beijing (CN); Lingling Xiao, Beijing (CN)

(21) Appl. No.: 18/260,357

(22) PCT Filed: Jan. 5, 2021
(86) PCT No.: PCT/CN2021/070286

§ 371 Date: Jul. 5, 2023

(51) Int. Cl. H04W 72/232

(52) U.S. Cl. CPC H04W 72/232; H04L 5/0007

(57) ABSTRACT

Apparatuses, methods, and systems are disclosed for transmission timing based on downlink control information. One method (600) includes transmitting (602) first downlink control information indicating a first transmission configuration indicator for a user equipment to receive a first physical downlink shared channel transmission. The method (600) includes transmitting (604) the first physical downlink shared channel transmission with the first transmission configuration indicator if a time between the first downlink control information and the first physical downlink shared channel transmission is greater than or equal to a first time. The method (600) includes transmitting (606) second physical downlink shared channel transmissions with the first transmission configuration indicator after a second time, wherein the second time is after a first acknowledgement corresponding to the first downlink control information has been received.

### FIELD

The subject matter disclosed herein relates generally to wireless communications and more particularly relates to transmission timing based on downlink control information.

### BACKGROUND

The following abbreviations are herewith defined, at least some of which are referred to within the following description: Third Generation Partnership Project (“3GPP”), 5G Globally Unique Temporary UE Identifier (“5G-GUTI”), 5G QoS Indicator (“5QI”), Authentication Authorization and Accounting (“AAA”), Acknowledge Mode (“AM”), Access and Mobility Management Function (“AMF”), Aperiodic (“AP”), Authentication Server Function (“AUSF”), Backhaul (“BH”), Broadcast Multicast (“BM”), Buffer Occupancy (“BO”), Base Station (“BS”), Buffer Status Report (“BSR”), Bandwidth (“BW”), Bandwidth Part (“BWP”), Carrier Aggregation (“CA”), Code Block Group (“CBG”), CBG Flushing Out Information (“CBGFI”), CBG Transmission Information (“CBGTI”), Component Carrier (“CC”), Control Channel Element (“CCE”), Code Division Multiplexing (“CDM”), Control Element (“CE”), Coordinated Multipoint (“CoMP”), Categories of Requirements (“CoR”), Control Resource Set (“CORESET”), Cyclic Prefix (“CP”), Cyclic Prefix OFDM (“CP-OFDM”), Cyclic Redundancy Check (“CRC”), CSI-RS Resource Indicator (“CRI”), Cell RNTI (“C-RNTI”), Channel State Information (“CSI”), CSI IM (“CSI-IM”), CSI RS (“CSI-RS”), Channel Quality Indicator (“CQI”), Central Unit (“CU”), Codeword (“CW”), Downlink Assignment Index (“DAI”), Downlink Control Information (“DCI”), Downlink Feedback Information (“DFI”), Downlink (“DL”), Discrete Fourier Transform Spread OFDM (“DFT-s-fOFDM”), Demodulation Reference Signal (“DMRS” or “DM-RS”), Data Radio Bearer (“DRB”), Dedicated Short-Range Communications (“DSRC”), Distributed Unit (“DU”), Enhanced Mobile Broadband (“eMBB”), Evolved Node B (“eNB”), Enhanced Subscriber Identification Module (“eSIM”), Enhanced (“E”), Edge Application Server (“EAS”), Edge Configuration Server (“ECS”), Edge Enabler Client (“EEC”), Edge Enabler Server (“EES”), Frequency Division Duplex (“FDD”), Frequency Division Multiplexing (“FDM”), Frequency Division Multiple Access (“FDMA”), Fully-Qualified Domain Name (“FQDN”), Frequency Range (“FR”), 450 MHz-6000 MHz (“FR1”), 24250 MHz-52600 MHz (“FR2”), Globally Unique Temporary UE Identifier (“GUTI”), Hybrid Automatic Repeat Request (“HARQ”), High-Definition Multimedia Interface (“HDMI”), High-Speed Train (“HST”), Integrated Access Backhaul (“IAB”), Identity or Identifier or Identification (“ID”), Information Element (“IE”), Interference Measurement (“IM”), International Mobile Subscriber Identity (“IMSI”), Internet-of-Things (“IoT”), Internet Protocol (“IP”), Joint Transmission (“JT”), Key Derivation Function (“KDF”), Level 1 (“L1”), L1 RSRP (“L1-RSRP”), L1 SINR (“L1-SINR”), Level 2 (“L2”), Logical Channel (“LCH”), Logical Channel Group (“LCG”), Logical Channel ID (“LCID”), Logical Channel Prioritization (“LCP”), Layer Indicator (“LI”), Least-Significant Bit (“LSB”), Long Term Evolution (“LTE”), Levels of Automation (“LoA”), Medium Access Control (“MAC”), Message Authentication Code for Integrity (“MAC-I”), Modulation Coding Scheme (“MCS”), Multi DCI (“M-DCI”), Mobile Edge Computing (“MEC”), Master Information Block (“MIB”), Multiple Input Multiple Output (“MIMO”), Maximum Permissible Exposure (“MPE”), Most-Significant Bit (“MSB”), Mobile Station International Subscriber Directory Number (“MSISDN”), Mobile-Termination (“MT”), Machine Type Communication (“MTC”), Multi PDSCH (“Multi-PDSCH”), Multi TRP (“M-TRP”), Multi-User (“MU”), Multi-User MIMO (“MU-MIMO”), Minimum Mean Square Error (“MMSE”), Negative-Acknowledgment (“NACK”) or (“NAK”), Network Access Identifier (“NAI”), Non Access Stratum (“NAS”), Non-Coherent Joint Transmission (“NCJT”), Network Exposure Function (“NEF”), Next Generation (“NG”), Next Generation Node B (“gNB”), Generic Public Subscription Identifier (“GPSI”), New Radio (“NR”), Non-Zero Power (“NZP”), NZP CSI-RS (“NZP-CSI-RS”), Orthogonal Frequency Division Multiplexing (“OFDM”), Peak-to-Average Power Ratio (“PAPR”), Physical Broadcast Channel (“PBCH”), Physical Downlink Control Channel (“PDCCH”), Physical Downlink Shared Channel (“PDSCH”), PDSCH Configuration (“PDSCH-Config”), Policy Control Function (“PCF”), Packet Data Convergence Protocol (“PDCP”), Packet Data Network (“PDN”), Protocol Data Unit (“PDU”), Permanent Equipment Identifier (“PEI”), Public Land Mobile Network (“PLMN”), Precoding Matrix Indicator (“PMI”), ProSe Per Packet Priority (“PPPP”), ProSe Per Packet Reliability (“PPPR”), Physical Resource Block (“PRB”), Packet Switched (“PS”), Physical Sidelink Control Channel (“PSCCH”), Physical Sidelink Shared Channel (“PSSCH”), Phase Tracking RS (“PTRS” or “PT-RS”), Physical Uplink Control Channel (“PUCCH”), Physical Uplink Shared Channel (“PUSCH”), Quasi Co-Located (“QCL”), Quality of Service (“QoS”), Random Access Channel (“RACH”), Radio Access Network (“RAN”), Radio Access Technology (“RAT”), Resource Element (“RE”), Radio Frequency (“RF”), Rank Indicator (“RI”), Radio Link Control (“RLC”), Radio Link Failure (“RLF”), Radio Network Temporary Identifier (“RNTI”), Resource Pool (“RP”), Radio Resource Control (“RRC”), Remote Radio Head (“RRH”), Reference Signal (“RS”), Reference Signal Received Power (“RSRP”), Reference Signal Received Quality (“RSRQ”), Redundancy Version (“RV”), Receive (“RX”), Security Association (“SA”), Service Based Architecture (“SBA”), Single Carrier Frequency Domain Spread Spectrum (“SC-FDSS”), Secondary Cell (“SCell”), Spatial Channel Model (“SCM”), Sub Carrier Spacing (“SCS”), Single DCI (“S-DCI”), Spatial Division Multiplexing (“SDM”), Service Data Unit (“SDU”), Single Frequency Network (“SFN”), Subscriber Identity Module (“SIM”), Signal-to-Interference Ratio (“SINR”), Sidelink (“SL”), Session Management Function (“SMF”), Sequence Number (“SN”), Semi Persistent (“SP”), Scheduling Request (“SR”), SRS Resource Indicator (“SRI”), Sounding Reference Signal (“SRS”), Synchronization Signal (“SS”), SS/PBCH Block (“SSB”), Subscription Concealed Identifier (“SUCI”), Subscription Permanent Identifier (“SUPI”), Transport Block (“TB”), Transmission Configuration Indication (“TCI”), Time Division Duplex (“TDD”), Time Division Multiplexing (“TDM”), Temporary Mobile Subscriber Identity (“TMSI”), Transmit Power Control (“TPC”), Transmitted Precoding Matrix Indicator (“TPMI”), Transmission Reception Point (“TRP”), Transmission Reference Signal (“TRS”), Technical Standard (“TS”), Transmit (“TX”), Unified Data Management (“UDM”), User Data Repository (“UDR”), User Entity/Equipment (Mobile Terminal) (“UE”), Universal Integrated Circuit Card (“UICC”), Uplink (“UL”), Uplink Power Control (“UL-PC”), Unacknowledged Mode (“UM”), Universal Mobile Telecommunications System (“UMTS”), LTE Radio Interface (“Uu interface”), User Plane (“UP”), User Plane Function (“UPF”), Ultra Reliable Low Latency Communication (“URLLC”), Universal Subscriber Identity Module (“USIM”), Universal Terrestrial Radio Access Network (“UTRAN”), Vehicle to Everything (“V2X”), Voice Over IP (“VoIP”), Visited Public Land Mobile Network (“VPLMN”), Virtual Resource Block (“VRB”), Vehicle RNTI (“V-RNTI”), Worldwide Interoperability for Microwave Access (“WiMAX”), Zero Forcing (“ZF”), Zero Power (“ZP”), and ZP CSI-RS (“ZP-CSI-RS”). As used herein, “HARQ-ACK” may represent collectively the Positive Acknowledge (“ACK”) and the Negative Acknowledge (“NAK”). ACK means that a TB is correctly received while NAK means a TB is erroneously received.

In certain wireless communications networks, an TCIs may be used.

### BRIEF SUMMARY

Methods for transmission timing based on downlink control information are disclosed. Apparatuses and systems also perform the functions of the methods. In one embodiment, the method includes transmitting first downlink control information indicating a first transmission configuration indicator for a user equipment to receive a first physical downlink shared channel transmission. In certain embodiments, the method includes transmitting the first physical downlink shared channel transmission with the first transmission configuration indicator if a time between the first downlink control information and the first physical downlink shared channel transmission is greater than or equal to a first time. In various embodiments, the method includes transmitting second physical downlink shared channel transmissions with the first transmission configuration indicator after a second time, wherein the second time is after a first acknowledgement corresponding to the first downlink control information has been received.

An apparatus for transmission timing based on downlink control information, in one embodiment, includes a transmitter that: transmits first downlink control information indicating a first transmission configuration indicator for a user equipment to receive a first physical downlink shared channel transmission; transmits the first physical downlink shared channel transmission with the first transmission configuration indicator if a time between the first downlink control information and the first physical downlink shared channel transmission is greater than or equal to a first time; and transmits second physical downlink shared channel transmissions with the first transmission configuration indicator after a second time, wherein the second time is after a first acknowledgement corresponding to the first downlink control information has been received.

In various embodiments, a method for transmission timing based on downlink control information includes receiving first downlink control information indicating a first transmission configuration indicator for a user equipment to receive a first physical downlink shared channel transmission. In certain embodiments, the method includes receiving the first physical downlink shared channel transmission with the first transmission configuration indicator if a time between the first downlink control information and the first physical downlink shared channel transmission is greater than or equal to a first time. In various embodiments, the method includes transmitting a first acknowledgement corresponding to the first downlink control information.

In some embodiments, an apparatus for transmission timing based on downlink control information includes a receiver that: receives first downlink control information indicating a first transmission configuration indicator for the apparatus to receive a first physical downlink shared channel transmission; and receives the first physical downlink shared channel transmission with the first transmission configuration indicator if a time between the first downlink control information and the first physical downlink shared channel transmission is greater than or equal to a first time. In various embodiments, the apparatus includes a transmitter that transmits a first acknowledgement corresponding to the first downlink control information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for transmission timing based on downlink control information;

FIG. 2 is a schematic block diagram illustrating one embodiment of an apparatus that may be used for transmission timing based on downlink control information;

FIG. 3 is a schematic block diagram illustrating one embodiment of an apparatus that may be used for transmission timing based on downlink control information;

FIG. 4 is a timing diagram illustrating one embodiment of communication timing;

FIG. 5 is a timing diagram illustrating another embodiment of communication timing;

FIG. 6 is a schematic flow chart diagram illustrating one embodiment of a method for transmission timing based on downlink control information; and

FIG. 7 is a schematic flow chart diagram illustrating another embodiment of a method for transmission timing based on downlink control information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

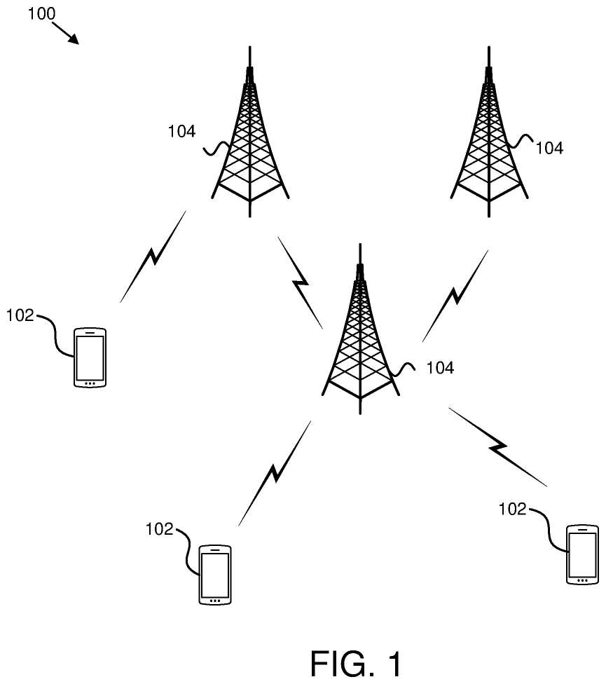

FIG. 1 depicts an embodiment of a wireless communication system 100 for transmission timing based on downlink control information. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a RAN, a relay node, a device, a network device, an IAB node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the 3GPP protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may transmit first downlink control information indicating a first transmission configuration indicator for a user equipment to receive a first physical downlink shared channel transmission. In certain embodiments, the network unit 104 may transmit the first physical downlink shared channel transmission with the first transmission configuration indicator if a time between the first downlink control information and the first physical downlink shared channel transmission is greater than or equal to a first time. In various embodiments, the network unit 104 may transmit second physical downlink shared channel transmissions with the first transmission configuration indicator after a second time, wherein the second time is after a first acknowledgement corresponding to the first downlink control information has been received. Accordingly, a network unit 104 may be used for transmission timing based on downlink control information.

In some embodiments, a remote unit 102 may receive first downlink control information indicating a first transmission configuration indicator for a user equipment to receive a first physical downlink shared channel transmission. In certain embodiments, the remote unit 102 may receive the first physical downlink shared channel transmission with the first transmission configuration indicator if a time between the first downlink control information and the first physical downlink shared channel transmission is greater than or equal to a first time. In various embodiments, the remote unit 102 may transmit a first acknowledgement corresponding to the first downlink control information. Accordingly, a remote unit 102 may be used for transmission timing based on downlink control information.

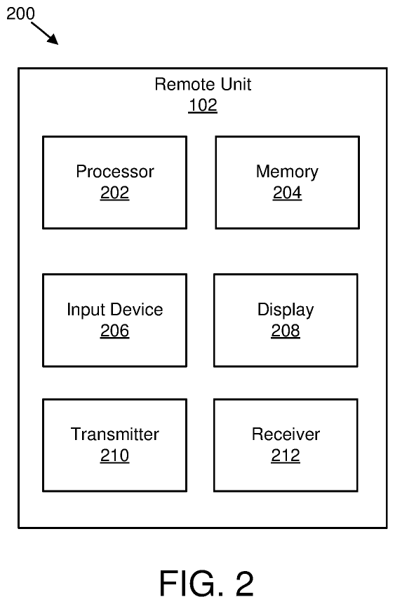

FIG. 2 depicts one embodiment of an apparatus 200 that may be used for transmission timing based on downlink control information. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

In various embodiments, the receiver 212: receives first downlink control information indicating a first transmission configuration indicator for the apparatus to receive a first physical downlink shared channel transmission; and receives the first physical downlink shared channel transmission with the first transmission configuration indicator if a time between the first downlink control information and the first physical downlink shared channel transmission is greater than or equal to a first time. In certain embodiments, the transmitter 210 transmits a first acknowledgement corresponding to the first downlink control information.

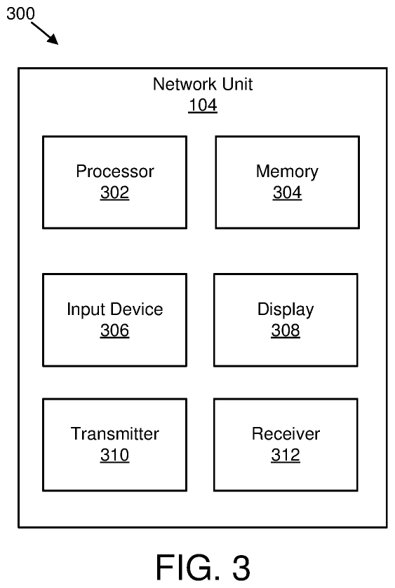

FIG. 3 depicts one embodiment of an apparatus 300 that may be used for transmission timing based on downlink control information. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, the transmitter 310: transmits first downlink control information indicating a first transmission configuration indicator for a user equipment to receive a first physical downlink shared channel transmission; transmits the first physical downlink shared channel transmission with the first transmission configuration indicator if a time between the first downlink control information and the first physical downlink shared channel transmission is greater than or equal to a first time; and transmits second physical downlink shared channel transmissions with the first transmission configuration indicator after a second time, wherein the second time is after a first acknowledgement corresponding to the first downlink control information has been received.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In certain embodiments, if a DCI-based beam indication is applied, a DCI (e.g., format 1_1 or 1_2, beam indication DCI) may be sent to a UE to signal a beam. In such embodiments, to inform a gNB that the UE receives the beam information correctly, the UE may send an acknowledgement to the gNB after receiving the DCI. Various methods and/or timelines may be used for the UE to transmit the ACK corresponding to the DCI it receives, and there may be various gNB behaviors.

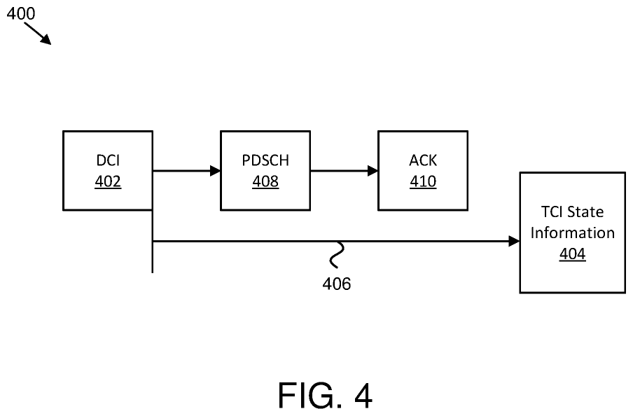

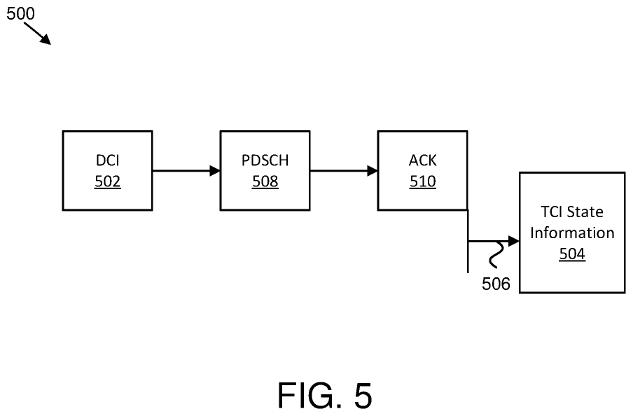

In various embodiments, such as for FR2, there may be a predetermined timing of events after DCI (e.g., format 1_1 or 1_2) signaling a TCI state is sent to a UE. As may be appreciated, an L1-based TCI state may facilitate expediting a beam switching process. In some embodiments, to reduce delay, a new beam may become active and may be applied to a following PDSCH (e.g., for DL TCI), PUSCH (e.g., for UL TCI), or for both PDSCH and PUSCH (e.g., for DL and UL joint TCI) as soon as possible. In various embodiments, depending on a scope of signaling, a new beam may be applied to some PDCCH and some PUCCH. Certain embodiments corresponding to timing of events and related behavior are illustrated and/or described in relation to FIG. 4 and FIG. 5.

FIG. 4 is a timing diagram illustrating one embodiment of communication timing 400. At a first time, DCI 402 (e.g., a DCI format 1_1 or 1_2) is transmitted from a network unit 104 (e.g., gNB) to a remote unit 102 (e.g., UE). The DCI 402 may include parameters such as K0 (e.g., used to derive a slot offset from the slot where DCI is received, offset between a DL slot where DCI is received and a DL slot where PDSCH data is scheduled), S (e.g., a start symbol—first symbol in a slot in which PDSCH will be received), L (e.g., an allocation length in number of OFDM symbols), and/or TCI state information 404 (e.g., new TCI state for PDSCH and/or PDCCH). A TCI_activation_time 406 (e.g., time delay before a new TCI state is activated) may be transmitted from a gNB to the UE via RRC signaling. At a second time, PDSCH 408 is transmitted. At a third time, ACK 410 is transmitted. As may be appreciated, there may be a certain number of slots (e.g., k slots) between the PDSCH 408 transmission and the ACK 410 transmission. After the TCI_activation_time 406, TCI state information 404 from the DCI 402 may be used for PDSCH and/or PDCCH (e.g., further PDSCH, not PDSCH 408).

In various embodiments, the UE may apply a TCI state indicated by the TCI state information 404 in the DCI 402 to receive the scheduled PDSCH 408 unless the time between the DCI 402 and the PDSCH 408 is too short (e.g., shorter than timeDurationForQCL). If the time between the DCI 402 and the PDSCH 408 is too short for applying the TCI state, a current (e.g., last indicated) common beam may be applied to the PDSCH 408. In certain embodiments, a time between the DCI 402 carrying the TCI state and the PDSCH 408 may be determined by the parameters K0, S, and L of the DCI 402. In some embodiments, if the time between the DCI 402 and the PDSCH 408 is at least timeDurationForQCL, the UE may receive the PDSCH 408 with the indicated TCI state in the DCI 402. In various embodiments, if the time between the DCI 402 and the PDSCH 408 is less than timeDurationForQCL, the UE may not have time to switch to a TCI state indicated by the DCI 402 if the TCI state is different from a TCI state previously signaled by previous DCI. In such embodiments, the UE may receive the PDSCH 408 with the TCI state (e.g., RX beam) previously signaled by previous DCI.

In various embodiments, a purpose of TCI state information in DCI 402 may be to configure a new common beam for a UE for future transmissions and/or to indicate a beam the UE may use to receive PDSCH if time allows. In such embodiments, a TCI state (e.g., new TCI state) of the TCI state information indicated in the DCI 402 configures the common beam for future DL and UL transmissions. If the TCI state is activated after a certain time (e.g., the TCI_activation_time 406—defined in millisecond or symbols) after the UE receives the DCI 402, the TCI state may be used to configure the common beam for future transmissions only after the UE has transmitted the ACK 410 to the gNB (e.g., the ACK 410 transmission signals that the UE has successfully received the DCI 402 indicating the TCI state information). As may be appreciated, if the TCI state becomes active before the gNB receives the ACK 410, and the UE did not receive the DCI 402 correctly (e.g., ACK 410 would not be sent), the gNB and UE may have different understandings of the TCI state and this may lead to a UE error in receiving future PDSCH. In certain embodiments, the TCI_activation_time 406 (e.g., time for the TCI state to be active) may be after a last symbol of the ACK 410 is transmitted plus a time required by the gNB to process the ACK 410 (e.g., a time to process the ACK 410 may be a minimum duration of one OFDM symbol). It should be noted that, while a time the UE sends the ACK 410 is determined by the DCI 402, the UE is not expected to be signaled in the DCI 402 to transmit the ACK 410 at or after the TCI_activation_time 406.

In some embodiments, an UL carrier carrying the ACK 410 (e.g., in PUCCH or PUSCH) may have different OFDM numerology than a DL carrier carrying the DCI 402 and PDSCH 408, a symbol duration may be based on PUCCH numerology. In various embodiments, a symbol duration may be a SCS of a CORESET (e.g., PDCCH) used for transmission of the DCI 402, or a minimum of a PUCCH and PDCCH SCS. In certain embodiments, the TCI_activation_time 406 may not be smaller than a UE reported threshold timeDurationForQCL to facilitate the UE switching to a new beam. In some embodiments, after the gNB receives the ACK 410 from the UE indicating it has successfully received the DCI 402, the gNB is assured that the TCI state has been configured at the UE and may be used for further PDSCH transmissions. In such embodiments, if the gNB does not receive the ACK 410 (e.g., receives either a NACK or an absence of an ACK), the gNB may assume the UE did not receive the DCI 402 indicating the TCI state. Accordingly, the gNB will keep using the last TCI state known to the UE (e.g., until it transmits another DCI and receives a corresponding ACK). In certain embodiments, the gNB may retransmit DCI indicating TCI state information (e.g., at a future time).

FIG. 5 is a timing diagram illustrating another embodiment of communication timing 500. At a first time, DCI 502 (e.g., a DCI format 1_1 or 1_2) is transmitted from a network unit 104 (e.g., gNB) to a remote unit 102 (e.g., UE). The DCI 502 may include parameters such as K0 (e.g., used to derive a slot offset from the slot where DCI is received, offset between a DL slot where DCI is received and a DL slot where PDSCH data is scheduled), S (e.g., a start symbol—first symbol in a slot in which PDSCH will be received), L (e.g., an allocation length in number of OFDM symbols), and/or TCI state information 504 (e.g., new TCI state for PDSCH and/or PDCCH). A TCI_activation_time1 506 (e.g., time delay before a new TCI state is activated) may be transmitted from a gNB to the UE via RRC signaling. At a second time, PDSCH 508 is transmitted. At a third time, ACK 510 is transmitted. As may be appreciated, there may be a certain number of slots (e.g., k slots) between the PDSCH 508 transmission and the ACK 510 transmission. After the TCLactivation_time1 506, TCI state information 504 from the DCI 502 may be used for PDSCH and/or PDCCH.

In various embodiments, if a TCI state indicated by the TCI state information 504 is activated after a certain time (e.g., TCI_activation_time1 506—defined in milliseconds or symbols) after the UE transmits the ACK 510 to signal to the gNB that the UE has received the DCI 502 successfully, the gNB may be allowed sufficient time to process the ACK 510 after it has received it. Accordingly, in such embodiments, the TCI_activation_time1 506 may be at least one OFDM symbol (e.g., a minimum time required for the gNB to decode the PUCCH or PUSCH carrying the ACK 510).

In some embodiments, an UL carrier carrying the ACK 510 (e.g., in PUCCH or PUSCH) may have different OFDM numerology than a DL carrier carrying the DCI 502 and PDSCH 508, a symbol duration may be based on PUCCH numerology. In various embodiments, a symbol duration may be a SCS of a CORESET (e.g., PDCCH) used for transmission of the DCI 502, or a minimum of a PUCCH and PDCCH SCS. In certain embodiments, if the gNB does not receive the ACK 510 corresponding to the DCI 502, the gNB may assume that the UE did not receive the DCI 502 indicating the TCI state information 504. Therefore, in such embodiments, the gNB will not apply a TCI state identified by the TCI state information 504 to the following PDSCH until the gNB has sent another DCI carrying the TCI state and received a corresponding ACK. In some embodiments, a time offset from the end of the DCI 502 to a time a TCI state becomes active may be at least a UE reported capability parameter timeDurationForQCL to enable the UE to prepare a new beam for future transmissions. In FIG. 5, the time between the DCI 502 and a new beam activation time is the summation of the time from the DCI 502 to the PDSCH 508, from the PDSCH 508 to the ACK 510, and the TCI_activation_time1 506. As may be appreciated, because both the time from the DCI 502 to the PDSCH 508 and the from the PDSCH 508 to the ACK 510 are dynamically indicated by the DCI 502, when the gNB configures the TCI_activation_time1 506 the gNB may set the TCI_activation_time1 506 using the smallest values of K0 and K1 (e.g., shortest delay between the DCI 502 and the ACK 510). K1 may refer to an offset between a DL slot where the data is scheduled on the PDSCH 508 and an UL slot where the ACK 510 is to be sent.

In various embodiments, the UE may apply a TCI state indicated by the TCI state information 504 in the DCI 502 to receive the scheduled PDSCH 508 unless the time between the DCI 502 and the PDSCH 508 is too short (e.g., shorter than timeDurationForQCL). If the time between the DCI 502 and the PDSCH 508 is too short for applying the TCI state, a current (e.g., last indicated) common beam may be applied to the PDSCH 508. In certain embodiments, a time between the DCI 502 carrying the TCI state and the PDSCH 508 may be determined by the parameters K0, S, and L of the DCI 502. In some embodiments, if the time between the DCI 502 and the PDSCH 508 is at least timeDurationForQCL, the UE may receive the PDSCH 508 with the indicated TCI state in the DCI 502. In various embodiments, if the time between the DCI 502 and the PDSCH 508 is less than timeDurationForQCL, the UE may not have time to switch to a TCI state indicated by the DCI 502 if the TCI state is different from a TCI state previously signaled by previous DCI. In such embodiments, the UE may receive the PDSCH 508 with the TCI state (e.g., RX beam) previously signaled by previous DCI.

In certain embodiments corresponding to FIG. 4 and/or FIG. 5, the parameter TCI_activation_time 406 or TCI_activation_time1 506 may be configured by a gNB through RRC signaling. Accordingly, new UE capability may not be needed at least because the UE already reports its timeDurationForQCL as the time required to switch to a new beam. In some embodiments, the gNB may configure the TCI_activation_time 406 to be at least timeDurationForQCL, or the gNB may configure TCI_activation_time1 506 so that the total time from the last symbol of the DCI 502 to the time a new TCI state becomes active is at least timeDurationForQCL so the UE will have sufficient time to switch to a new beam corresponding to the new TCI state for the next PDSCH which will use the newly signaled TCI state. In various embodiments, if a beam indicated by the DCI (e.g., 402, 502) is the same as a beam corresponding to a TCI state currently in use (e.g., if there is insufficient time for the UE to switch beams), the UE will use a TCI state indicated by the last DCI (e.g., which in this case is the same beam indicated by the new DCI). In such embodiments, if the TCI state does not change from a prior DCI to a current DCI, the gNB has more flexibility in terms of timing and may make a scheduling decision based on its implementation.

In some embodiments, if a new TCI state is applied to a PDCCH transmission (e.g., in some or all CORESETs), a PUSCH transmission, and/or a PUCCH transmission (e.g., in some or all the PUCCH resources), a UE may start applying the new TCI state to the corresponding channel transmission after the TCI_activation_time 406 or the TCI_activation_time1 506.

In certain embodiments, if an application time of a new TCI state is counted from the last symbol of the DCI carrying the new TCI state in terms of OFDM symbols (e.g., shown as the TCI_activation_time 406 in FIG. 4), the application time may be longer than the last symbol of a PUCCH transmission or a PUSCH transmission carrying the ACK corresponding to the DCI indicating the new TCI state by at least one OFDM symbol of the numerology of the PUCCH transmission. In various embodiments, the time TCI_activation_time 406 may not be smaller than a UE configured threshold timeDurationForQCL.

In some embodiments, if an application time of a new TCI state is counted from the last symbol of a PUCCH transmission or a PUSCH transmission carrying ACK corresponding to the DCI indicating the new TCI state in terms of OFDM symbols (e.g., shown as the TCI_activation_time1 506 in FIG. 5), the application time may be at least one symbol of the numerology of the PUCCH transmission. In such embodiments, a time offset from the end of the DCI to the time the new TCI state becomes active may also be at least a UE configured parameter timeDurationForQCL.

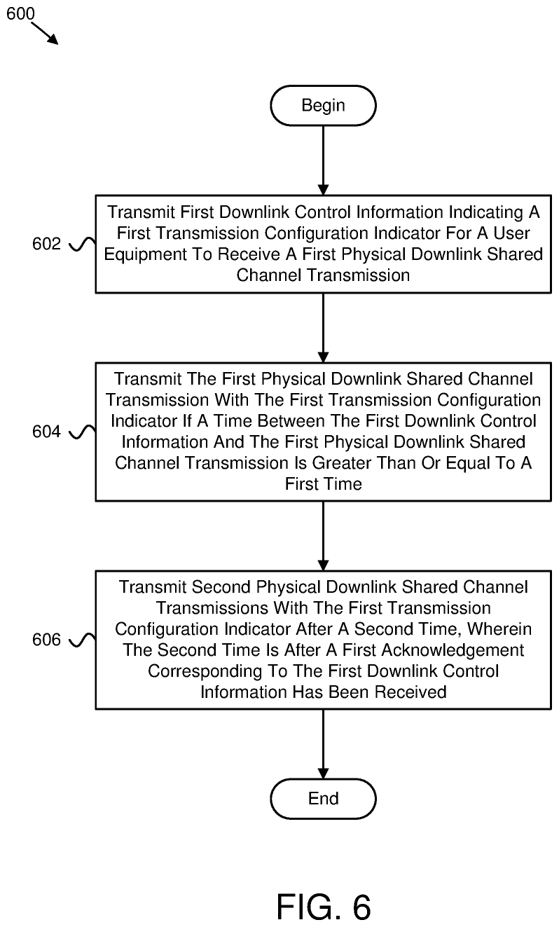

FIG. 6 a schematic flow chart diagram illustrating one embodiment of a method 600 for transmission timing based on downlink control information. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

The method 600 may include transmitting 602 first downlink control information indicating a first transmission configuration indicator for a user equipment to receive a first physical downlink shared channel transmission. In certain embodiments, the method 600 includes transmitting 604 the first physical downlink shared channel transmission with the first transmission configuration indicator if a time between the first downlink control information and the first physical downlink shared channel transmission is greater than or equal to a first time. In various embodiments, the method 600 includes transmitting 606 second physical downlink shared channel transmissions with the first transmission configuration indicator after a second time, wherein the second time is after a first acknowledgement corresponding to the first downlink control information has been received.

In certain embodiments, the method 600 further comprises transmitting the first physical downlink shared channel transmission with a second transmission configuration indicator if the time between the first downlink control information and the first physical downlink shared channel transmission is less than the first time, wherein the second transmission configuration indicator is indicated in second downlink control information for which a second acknowledgement corresponding to the second downlink control information has been received. In some embodiments, the second time is measured from a time at which the first downlink control information is transmitted, and the second time is at least one orthogonal frequency demodulation multiplexing symbol after the first acknowledgement.

In various embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel. In one embodiment, the second time is measured from the first acknowledgement, and the second time is at least one orthogonal frequency demodulation multiplexing symbol after the first acknowledgement. In certain embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In some embodiments, the first transmission configuration indicator is applied to at least one physical downlink control channel transmission in predetermined control resource sets after the second time. In various embodiments, the first transmission configuration indicator is applied to at least one physical uplink shared channel transmission, at least one physical uplink control channel transmission resources, or a combination thereof after the second time. In one embodiment, the method 600 further comprises transmitting a radio resource control transmission that configures the second time.

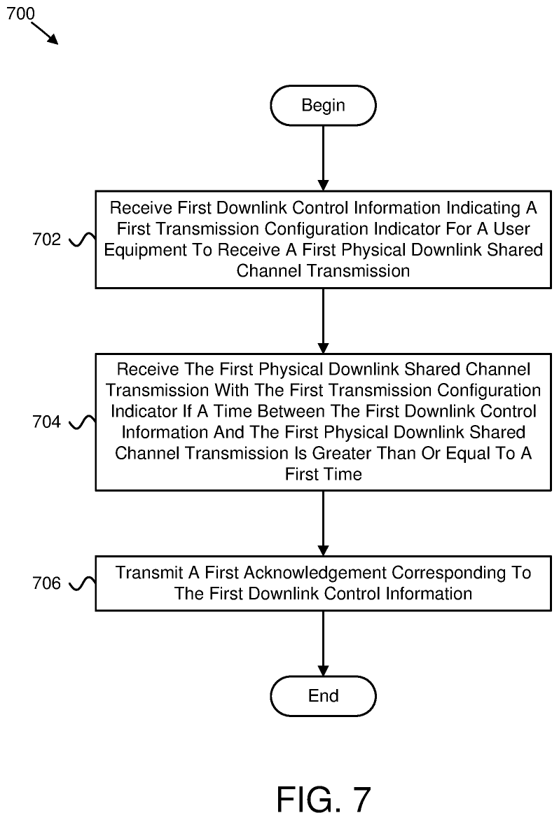

FIG. 7 is a schematic flow chart diagram illustrating another embodiment of a method 700 for transmission timing based on downlink control information. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

The method 700 may include receiving 702 first downlink control information indicating a first transmission configuration indicator for a user equipment to receive a first physical downlink shared channel transmission. In certain embodiments, the method 700 includes receiving 704 the first physical downlink shared channel transmission with the first transmission configuration indicator if a time between the first downlink control information and the first physical downlink shared channel transmission is greater than or equal to a first time. In various embodiments, the method 700 includes transmitting 706 a first acknowledgement corresponding to the first downlink control information.

In certain embodiments, the method 700 further comprises receiving the first physical downlink shared channel transmission with a second transmission configuration indicator if the time between the first downlink control information and the first physical downlink shared channel transmission is less than the first time, wherein the second transmission configuration indicator is indicated in second downlink control information for which a second acknowledgement corresponding to the second downlink control information has been transmitted.

In some embodiments, the method 700 further comprises receiving second physical downlink shared channel transmissions with the first transmission configuration indicator after a second time, wherein the second time is after the first acknowledgement. In various embodiments, the second time is measured from a time at which the first downlink control information is transmitted, and the second time is at least one orthogonal frequency demodulation multiplexing symbol after the first acknowledgement.

In one embodiment, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel. In certain embodiments, the second time is measured from the first acknowledgement, and the second time is at least one orthogonal frequency demodulation multiplexing symbol after the first acknowledgement.

In some embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel. In various embodiments, the method 700 further comprises receiving at least one physical downlink control channel transmission in predetermined control resource sets after the second time, wherein the first transmission configuration indicator is applied to the at least one physical downlink control channel transmission.

In one embodiment, the method 700 further comprises applying the first transmission configuration indicator to at least one physical uplink shared channel transmission, at least one physical uplink control channel transmission resources, or a combination thereof after the second time. In certain embodiments, the method 700 further comprises receiving a radio resource control transmission configuring the second time.

In one embodiment, a method comprises: transmitting first downlink control information indicating a first transmission configuration indicator for a user equipment to receive a first physical downlink shared channel transmission; transmitting the first physical downlink shared channel transmission with the first transmission configuration indicator if a time between the first downlink control information and the first physical downlink shared channel transmission is greater than or equal to a first time; and transmitting second physical downlink shared channel transmissions with the first transmission configuration indicator after a second time, wherein the second time is after a first acknowledgement corresponding to the first downlink control information has been received.

In certain embodiments, the method further comprises transmitting the first physical downlink shared channel transmission with a second transmission configuration indicator if the time between the first downlink control information and the first physical downlink shared channel transmission is less than the first time, wherein the second transmission configuration indicator is indicated in second downlink control information for which a second acknowledgement corresponding to the second downlink control information has been received.

In some embodiments, the second time is measured from a time at which the first downlink control information is transmitted, and the second time is at least one orthogonal frequency demodulation multiplexing symbol after the first acknowledgement.

In various embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In one embodiment, the second time is measured from the first acknowledgement, and the second time is at least one orthogonal frequency demodulation multiplexing symbol after the first acknowledgement.

In certain embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In some embodiments, the first transmission configuration indicator is applied to at least one physical downlink control channel transmission in predetermined control resource sets after the second time.

In various embodiments, the first transmission configuration indicator is applied to at least one physical uplink shared channel transmission, at least one physical uplink control channel transmission resources, or a combination thereof after the second time.

In one embodiment, the method further comprises transmitting a radio resource control transmission that configures the second time.

In one embodiment, an apparatus comprises: a transmitter that: transmits first downlink control information indicating a first transmission configuration indicator for a user equipment to receive a first physical downlink shared channel transmission; transmits the first physical downlink shared channel transmission with the first transmission configuration indicator if a time between the first downlink control information and the first physical downlink shared channel transmission is greater than or equal to a first time; and transmits second physical downlink shared channel transmissions with the first transmission configuration indicator after a second time, wherein the second time is after a first acknowledgement corresponding to the first downlink control information has been received.

In certain embodiments, the transmitter transmits the first physical downlink shared channel transmission with a second transmission configuration indicator if the time between the first downlink control information and the first physical downlink shared channel transmission is less than the first time, and the second transmission configuration indicator is indicated in second downlink control information for which a second acknowledgement corresponding to the second downlink control information has been received.

In some embodiments, the second time is measured from a time at which the first downlink control information is transmitted, and the second time is at least one orthogonal frequency demodulation multiplexing symbol after the first acknowledgement.

In various embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In one embodiment, the second time is measured from the first acknowledgement, and the second time is at least one orthogonal frequency demodulation multiplexing symbol after the first acknowledgement.

In certain embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In some embodiments, the first transmission configuration indicator is applied to at least one physical downlink control channel transmission in predetermined control resource sets after the second time.

In various embodiments, the first transmission configuration indicator is applied to at least one physical uplink shared channel transmission, at least one physical uplink control channel transmission resources, or a combination thereof after the second time.

In one embodiment, the transmitter transmits a radio resource control transmission that configures the second time.

In one embodiment, a method comprises: receiving first downlink control information indicating a first transmission configuration indicator for a user equipment to receive a first physical downlink shared channel transmission; receiving the first physical downlink shared channel transmission with the first transmission configuration indicator if a time between the first downlink control information and the first physical downlink shared channel transmission is greater than or equal to a first time; and transmitting a first acknowledgement corresponding to the first downlink control information.

In certain embodiments, the method further comprises receiving the first physical downlink shared channel transmission with a second transmission configuration indicator if the time between the first downlink control information and the first physical downlink shared channel transmission is less than the first time, wherein the second transmission configuration indicator is indicated in second downlink control information for which a second acknowledgement corresponding to the second downlink control information has been transmitted.

In some embodiments, the method further comprises receiving second physical downlink shared channel transmissions with the first transmission configuration indicator after a second time, wherein the second time is after the first acknowledgement.

In various embodiments, the second time is measured from a time at which the first downlink control information is transmitted, and the second time is at least one orthogonal frequency demodulation multiplexing symbol after the first acknowledgement.

In one embodiment, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In certain embodiments, the second time is measured from the first acknowledgement, and the second time is at least one orthogonal frequency demodulation multiplexing symbol after the first acknowledgement.

In some embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In various embodiments, the method further comprises receiving at least one physical downlink control channel transmission in predetermined control resource sets after the second time, wherein the first transmission configuration indicator is applied to the at least one physical downlink control channel transmission.

In one embodiment, the method further comprises applying the first transmission configuration indicator to at least one physical uplink shared channel transmission, at least one physical uplink control channel transmission resources, or a combination thereof after the second time.

In certain embodiments, the method further comprises receiving a radio resource control transmission configuring the second time.

In one embodiment, an apparatus comprises: a receiver that: receives first downlink control information indicating a first transmission configuration indicator for the apparatus to receive a first physical downlink shared channel transmission; and receives the first physical downlink shared channel transmission with the first transmission configuration indicator if a time between the first downlink control information and the first physical downlink shared channel transmission is greater than or equal to a first time; and a transmitter that transmits a first acknowledgement corresponding to the first downlink control information.

In certain embodiments, the receiver receives the first physical downlink shared channel transmission with a second transmission configuration indicator if the time between the first downlink control information and the first physical downlink shared channel transmission is less than the first time, and the second transmission configuration indicator is indicated in second downlink control information for which a second acknowledgement corresponding to the second downlink control information has been transmitted.

In some embodiments, the receiver receives second physical downlink shared channel transmissions with the first transmission configuration indicator after a second time, and the second time is after the first acknowledgement.

In various embodiments, the second time is measured from a time at which the first downlink control information is transmitted, and the second time is at least one orthogonal frequency demodulation multiplexing symbol after the first acknowledgement.

In one embodiment, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In certain embodiments, the second time is measured from the first acknowledgement, and the second time is at least one orthogonal frequency demodulation multiplexing symbol after the first acknowledgement.

In some embodiments, a subcarrier spacing of the at least one orthogonal frequency demodulation multiplexing symbol comprises a subcarrier spacing of a physical uplink control channel, a subcarrier spacing of a physical downlink control channel, or a minimum of the subcarrier spacing of the physical uplink control channel and the subcarrier spacing of the physical downlink control channel.

In various embodiments, the receiver receives at least one physical downlink control channel transmission in predetermined control resource sets after the second time, wherein the first transmission configuration indicator is applied to the at least one physical downlink control channel transmission.

In one embodiment, the apparatus further comprises a processor that applies the first transmission configuration indicator to at least one physical uplink shared channel transmission, at least one physical uplink control channel transmission resources, or a combination thereof after the second time.

In certain embodiments, the receiver receives a radio resource control transmission configuring the second time.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a base station, the method comprising:
transmitting first downlink control information (DCI) indicating a first transmission configuration indicator (TCI) for a user equipment (UE) to receive a first physical downlink shared channel (PDSCH) transmission;
transmitting the first PDSCH transmission with the first TCI if a time between the first DCI and the first PDSCH transmission is greater than or equal to a first time; and
transmitting second PDSCH transmissions with the first TCI after a second time, wherein the second time is after a first acknowledgement corresponding to the first DCI has been received.

2. The method of claim 1, further comprising transmitting the first PDSCH transmission with a second TCI if the time between the first DCI and the first PDSCH transmission is less than the first time, wherein the second TCI is indicated in second DCI for which a second acknowledgement corresponding to the second DCI has been received.

3. The method of claim 1, wherein the second time is measured from a time at which the first DCI is transmitted, and the second time is at least one orthogonal frequency demodulation multiplexing symbol after the first acknowledgement.

4. The method of claim 3, wherein a subcarrier spacing of the at least one orthogonal frequency demodulation multiplexing (OFDM) symbol comprises a subcarrier spacing of a physical uplink control channel (PUCCH), a subcarrier spacing of a physical downlink control channel (PDCCH), or a minimum of the subcarrier spacing of the PUCCH and the subcarrier spacing of the PDCCH.

5. The method of claim 1, wherein the second time is measured from the first acknowledgement, and the second time is at least one orthogonal frequency demodulation multiplexing (OFDM) symbol after the first acknowledgement.

6. The method of claim 5, wherein a subcarrier spacing of the at least one OFDM symbol comprises a subcarrier spacing of a physical uplink control channel (PUCCH), a subcarrier spacing of a physical downlink control channel (PDCCH), or a minimum of the subcarrier spacing of the PUCCH and the subcarrier spacing of the PDCCH.

7. The method of claim 1, wherein the first TCI is applied to at least one physical downlink control channel (PDCCH) transmission in predetermined control resource sets (CORESETs) after the second time.

8. The method of claim 1, wherein the first TCI is applied to at least one physical uplink shared channel (PUSCH) transmission, at least one physical uplink control channel (PUCCH) transmission resources, or a combination thereof after the second time.

9. The method of claim 1, further comprising transmitting a radio resource control (RRC) transmission that configures the second time.

10. A base station, comprising:
at least one memory; and
at least one processor coupled with the at least one memory and configured to cause the base station to:
transmit first downlink control information (DCI) indicating a first transmission configuration indicator (TCI) for a user equipment (UE) to receive a first physical downlink shared channel (PDSCH) transmission;
transmit the first PDSCH transmission with the first TCI if a time between the first DCI and the first PDSCH transmission is greater than or equal to a first time; and
transmit second PDSCH transmissions with the first TCI after a second time, wherein the second time is after a first acknowledgement corresponding to the first DCI has been received.

11. A user equipment (UE), comprising:
at least one memory; and
at least one processor coupled with the at least one memory and configured to cause the UE to:
receive first downlink control information (DCI) indicating a first transmission configuration indicator (TCI) for a user equipment (UE) to receive a first physical downlink shared channel (PDSCH) transmission;
receive the first PDSCH transmission with the first TCI if a time between the first DCI and the first PDSCH transmission is greater than or equal to a first time; and
transmit a first acknowledgement corresponding to the first DCI.

12. The UE of claim 11, wherein the processor is configured to cause the UE to receive the first PDSCH transmission with a second TCI if the time between the first DCI and the first PDSCH transmission is less than the first time, wherein the second TCI is indicated in second DCI for which a second acknowledgement corresponding to the second DCI has been transmitted.

13. The UE of claim 11, wherein the processor is configured to cause the UE to receive second PDSCH transmissions with the first TCI after a second time, wherein the second time is after the first acknowledgement.

14. The UE of claim 13, wherein the second time is measured from a time at which the first DCI is transmitted, and the second time is at least one orthogonal frequency demodulation multiplexing symbol after the first acknowledgement.

15. The UE of claim 13, wherein the processor is configured to cause the UE to receive at least one physical downlink control channel transmission in predetermined control resource sets after the second time, wherein the first TCI is applied to the at least one physical downlink control channel transmission.

16. A processor for wireless communication, comprising:
at least one controller coupled with at least one memory and configured to cause the processor to:
transmit first downlink control information (DCI) indicating a first transmission configuration indicator (TCI) for a user equipment (UE) to receive a first physical downlink shared channel (PDSCH) transmission;
transmit the first PDSCH transmission with the first TCI if a time between the first DCI and the first PDSCH transmission is greater than or equal to a first time; and
transmit second PDSCH transmissions with the first TCI after a second time, wherein the second time is after a first acknowledgement corresponding to the first DCI has been received.

17. The processor of claim 16, wherein the second time is measured from a time at which the first DCI is transmitted, and the second time is at least one orthogonal frequency demodulation multiplexing symbol after the first acknowledgement.

18. The processor of claim 17, wherein a subcarrier spacing of the at least one orthogonal frequency demodulation multiplexing (OFDM) symbol comprises a subcarrier spacing of a physical uplink control channel (PUCCH), a subcarrier spacing of a physical downlink control channel (PDCCH), or a minimum of the subcarrier spacing of the PUCCH and the subcarrier spacing of the PDCCH.

19. The processor of claim 16, wherein the second time is measured from the first acknowledgement, and the second time is at least one orthogonal frequency demodulation multiplexing (OFDM) symbol after the first acknowledgement.

20. The processor of claim 19, wherein a subcarrier spacing of the at least one OFDM symbol comprises a subcarrier spacing of a physical uplink control channel (PUCCH), a subcarrier spacing of a physical downlink control channel (PDCCH), or a minimum of the subcarrier spacing of the PUCCH and the subcarrier spacing of the PDCCH.
